(19) United States
(12) Patent Application Publication
(10) Pub. No.: US 2022/0107897 A1
(43) Pub. Date: Apr. 7, 2022

(54) CACHE PROBE TRANSACTION FILTERING

(71) Applicant: Intel Corporation, Santa Clara, CA (US)

(72) Inventors: David KEPPEL, Mountain View, CA (US); Swapna RAJ, Norwalk, CT (US); Kermin CHOFLEMING, Hudson, MA (US); Samantika S. SURY, Westford, MA (US)

(21) Appl. No.: 17/552,239

(22) Filed: Dec. 15, 2021

(51) Int. Cl. G06F 12/0842

(52) U.S. Cl. CPC G06F 12/0842

(57) ABSTRACT

Examples described herein relate to circuitry to selectively disable cache snoop operations issued by a particular processor or its cache manager based on data in a memory address range, to be accessed by the particular processor, having been flushed from one or more other cache devices accessible to other processors. At or after completion of flushing or scrubbing data in the memory address range to memory, the particular processor or its cache manager do not issue snoop operations for accesses to the memory address range. In response to an access by some other device to the memory address range, the processor or cache manager may resume issuing snoop operations.

### BACKGROUND

Multiprocessor systems that utilize multiple cache devices can encounter challenges with providing the latest version of data if the data has been processed and modified. A cache coherency protocol can be used to retrieve the latest version of the data. A cache directory (e.g., caching home agent (CHA)) can perform the cache coherency protocol. In the event of an access to an addressable memory region, the CHA can be probed to determine a cache or memory state of the addressable memory region.

Some systems include accelerator devices and share memory regions between the accelerators and cores over the lifetime of the program, even if they do not access the same data simultaneously. Some accelerators are designed to work on data sets which are much larger than the cache hierarchy. Thus, even if the cores have recently modified all of the data set, only a small part of the data set can be cached. In this situation, many CHA probe transactions are not serviced by the CHA and the CHA responds to many CHA probe transactions with a negative acknowledgement (NACK) to indicate a cache device does not store the data. In other words, memory accessed by the accelerator might be not cached and therefore not currently managed by the CHA. CHA probes are used to comply with the cache coherency protocol, but when the accelerator memory address access footprint has low overlap with core memory address access footprints, the probes may rarely yield an indication that data has been updated. Accordingly, there is a range of memory addresses which have a high rate of wasted CHA probes. For example, one or several cores previously accessed a range of memory address locations [A . . . B], the cores no longer access data in those locations, but an accelerator engine which is able to access data in [A . . . B], the accelerator probes the CHA because data associated with [A . . . B] can be cached.

A solution is that software for the application, runtime, or operating system evicts cacheable entries and then idles the core or otherwise does not to access or re-cache data in memory range [A . . . B]. In another example, Compute Express Link (CXL) allows virtual memory pages to be removed from CHA protection to reduce CXL traffic and CHA snoops when a GPU is making high-bandwidth access to the memory. See, for example, Compute Express Link (CXL) Specification revision 2.0, version 0.7 (2019), as well as earlier versions, later versions, and variations thereof.

Another solution to reducing snoop requests or probes is a hardware snoop filter, which tracks cache line state and filters coherency requests. When a device accesses data in memory, it consults the snoop filter to determine if data in the region of memory is stored in cache. If the region of memory is not identified by the snoop filter, the data in memory is used. If the region of memory is identified by the snoop filter, the CHA is consulted for coherency.

### BRIEF DESCRIPTION OF THE DRAWINGS

FIG. 1 depicts an example system.

FIG. 2 depicts an example system.

FIG. 3 depicts an example of path selection using a decision tree.

FIG. 4 depicts an example network interface device.

FIG. 5 depicts an example process.

FIG. 6 depicts an example system.

### DETAILED DESCRIPTION

Some examples include circuitry to selectively disable cache snoop operations or activities related to cache coherency issued by a particular processor or its cache manager (e.g., CHA) based on data in a memory address range, to be accessed by the particular processor, having been flushed from one or more other cache devices accessible to other processors. A CHA can include a separate cache agent (CA) and home agent (HA). A request can be issued to cause the one or more other cache devices accessible to other processors than the particular processor to flush or scrub data in the memory address range to memory from the cache device. At or after completion of flushing or scrubbing data in the memory address range to memory, the particular processor or its cache manager do not issue snoop operations for accesses to the memory address range. However, if one or more of the other processors access data in the memory address range and store such data to a second cache device among the one or more other cache devices, the particular processor can resume issuing snoop requests to at least the second cache device among the one or more other cache devices.

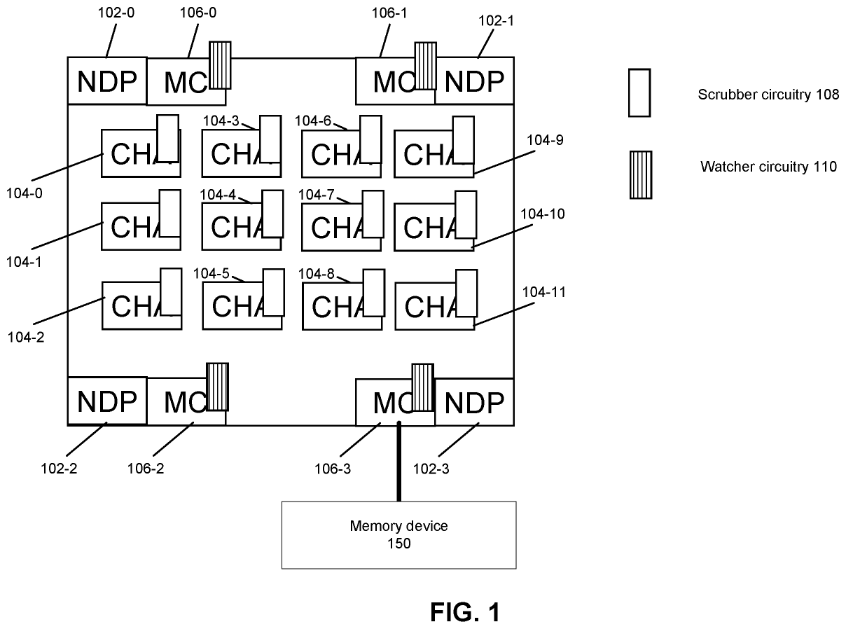

FIG. 1 depicts an example system. Near data processors (NDPs) 102-0 to 102-3 can include one or more of: a core, graphics processing unit (GPU), accelerator, infrastructure processing unit (IPU), data processing unit (DPU), CXL controller, distributed memory controller, and so forth. One or more of NDP 102-0 to 102-3 can execute software (e.g., application, virtual machine (VM), container, microservice) that can access data in memory (not shown) with or without snoop probes to one or more of CHAs 104-0 to 104-11, as described herein. In some examples, NDPs 102-0 to 102-3 can be co-located with respective memory controllers (MCs) 106-0 to 106-3 and is to access a range of memory addresses in memory 150 which is much larger than the cache size. In some examples, NDPs 102-0 to 102-3 can be positioned on a same die, integrated circuit, or circuit board as that of memory device 150 (e.g., volatile or non-volatile memory). NDPs 102-0 to 102-3 can access data from memory by issuing a memory read or write request to respective MC 106-0 to 106-3. If data has been accessed by an NDP, data can be in NDP's cache (not shown). In connection with an NDP accessing data from memory 150, NDP can request CHA to indicate whether data is stored in an associated cache and, if the data is stored in an associated cache, provide the data to the NDP.

On a request from a requester processor (e.g., NDP) to access data in the memory region [A . . . B], the requester processor can send a request “scrub [A . . . B]” to the CHAs 104-0 to 104-11. Software executed by the requester processor can indicate to scrubber circuitry 108 associated with a CHA to initiate scrub of data in a memory address range. For example, software can write the indication to a register or memory region and scrubber circuitry 108 can read such indication.

However, a processor can request scrubbing without explicit software requests. For example, an NDP may receive a block operation request and use the block's memory location to request scrubbing.

In some examples, CHAs 104-0 to 104-11 have an associated scrubber circuitry. An instance of scrubber circuitry 108 can be integrated into a CHA in some examples. Scrubber circuitry 108 can perform a drain of data from a cache associated with the memory address range to memory in order to reduce a number of snoop requests that the requester processor issues when accessing a memory address range. Scrubber circuitry 108 can request a writeback of data in cache lines associated with memory range [A . . . B] to scrub memory range [A . . . B] from the cache. When the cache has been scrubbed of memory range [A . . . B], scrubber circuitry 108 can send an acknowledgement (ACK) or other signal to watcher circuitry 110 associated with the requester processor to indicate that data associated with a memory address region [A . . . B] is not cached by an associated cache.

Watcher circuitry 110 can inform the requester processor whether CHA (snoop) probes are to be issued for an access to data within memory range [A . . . B]. After the software indicates to scrubber circuitry 108 associated with a CHA to initiate scrub of data in a memory address range, watcher circuitry 110 can monitor for ACKs in the range [A . . . B] from the CHAs that received a request to scrub the range [A . . . B]. Scrubbing data can include sending modified data to memory and deleting cached copy of data from its cache. Watcher circuitry 110 can track whether the cache device that stores data corresponding to range [A . . . B] drained the data. Scrubber circuitry 108 can report scrubbing complete, which can cause a decrement of the count of unscrubbed cache devices. After receipt of an ACK (scrub operation complete) from a CHA, watcher circuitry 110 can decrement a count of the number CHAs.

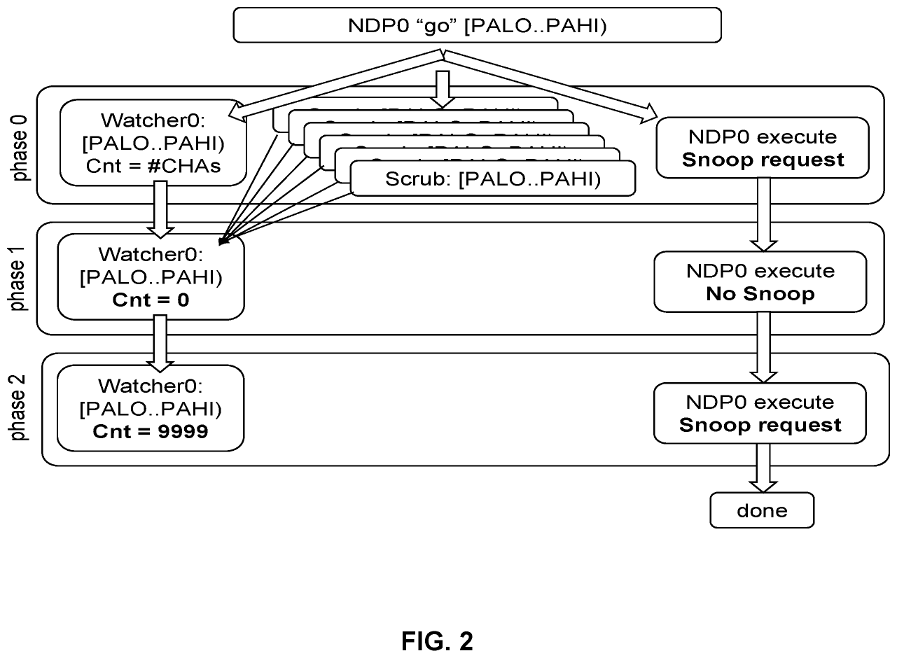

In accordance with an example described with respect to FIG. 2, as long as the count is non-zero, on a request to process data in memory range [A . . . B] from the requester processor, a snoop probe is to be issued because some CHAs have not flushed range [A . . . B]. If the count is zero, on a request to process data in memory range [A . . . B] from the requester processor, a snoop probe need not be issued. In some cases, the snoop probe may be more expensive (e.g., time, energy, power usage) than the memory reference, so avoiding the snoop probe may be a substantial advantage.

A subsequent memory read request to [A . . . B] after a flush to [A . . . B] sets a watch hit state and, on a request to process data in memory range [A . . . B] from the requester processor, a snoop probe is to be issued. Instance of watcher circuitry 110 can be integrated into memory controllers 106-0 to 106-3 and monitor read or write requests to specific memory regions. In some examples, watcher circuitry 110 can monitor multiple memory address ranges [A . . . B], [C . . . D], [E . . . F], and so forth.

In some examples, a requester processor can process data before a probe operation is responded-to (e.g., with updated data) and a result of processing can be provided if the data was unchanged compared to the data returned by a CHA. If different data was provided, the processed data can be discarded and the requester processor can process the updated data to provide a result.

Accordingly, examples can reduce a number of CHA probes based on scrubbing of data in other cache devices. CHA probes can cause on-die interconnect/in-node network (ODI/INN) traffic, which can interfere with core execution and cost energy/power spent in the ODI/CHA. Scrubbing can avoid traffic for cases that never needed to go to the ODI/CHA, and so can save both the energy/power of the traffic, and also avoid interfering with other traffic that did need ODI/CHA traffic.

In some examples, some cache devices are based on set-associative caches, and some sets do not manage data in the range [A . . . B]. In such case, those entries can be excluded from being sent scrubbing requests or snoop probes by watcher circuitry 110.

Watcher circuitry 110 can control whether an NDP performs speculative processing to hide CHA probe response latency. For example, where the CHA probes return no valid data and a memory read is to be performed, a processor may thus perform both a CHA probe and a speculative memory read. However, if the CHA often returns valid data, the memory reads are wasted and cause unwanted interference with other memory traffic. Thus, speculation might be disabled in cases which are likely to hit in the CHA, such as a slice of [A . . . B] which has recently been read by a core.

Watcher circuitry 110 can monitor approximate memory ranges, such as rounding down memory address A to a lower address or rounding up B to a higher address. The range [A . . . B] may be very large, and for some applications it may be desirable to have the NDP sweep the range low-to-high, and making results available for the NDP.

Overlap of processing performed by the NDP with processing by a core consuming the results of the NDP calculations can occur. A core can operate as though a coherency protocol is being applied for memory, but the NDP can withdraw a range [A . . . B] from application of the coherency protocol and so operate faster or more efficiently. When the core accesses data in memory range [A . . . B], a coherency protocol can be applied to memory range [A . . . B]. Accordingly, the core behavior with respect to memory range [A . . . B] can continue using a coherency protocol. For example, a core accessing to data in range [A . . . B] can force CHA probes for the whole region [A . . . B]. However, range [A . . . B] can be divided into regions {R0, R1, R2, . . . , RN}. If the core accesses any address R1, then NDP access to an address in R1 can trigger CHA probes. But the NDP can access data in other regions and not issue a CHA probe.

For example, regions [A . . . B] can be sliced into chunks of size 2^{N} and alignment 2^{N}, which may then be managed using a bit-mask. A core access to an address reads a few bits from the address and sets the corresponding bit in the mask. For example, with an 8-bit mask, 3 bits are read from the address and the corresponding 1-in-8 mask bit is set. An NDP load or store then skips CHA probes if the NDP address has the corresponding mask bit clear.

A GPU can access a local memory and the local memory is part of a cache coherency protocol. The GPU can have a local directory. However, cache lines which are cached remote (e.g., by a core in a different socket) can be fetched lazily (e.g., the fetch is not started until the GPU needs the data). Pre-scrubbing of ranges which are likely to have some remote-cached data can reduce the number of slow/remote fetches. A directory can refer to a listing of memory addresses associated with data stored in a cache. For example, a directory can refer to a set of addresses {B, E, H, K, N, . . . }. On a cache miss, the core can determine from the address (e.g., K) which directory is associated with a specific address, and then consults that directory. The directory will either note which cache(s) have the most-recent data values and forward the miss request to a source device, which in turn can send the value; or the directory has no note, in which case the value is in memory. The directory can identify where the data is stored. Updates made to data storage locations can cause update of the directory. For a cache miss, the core can consult the directory.

Where a directory is used, the scrubber and watcher circuitries cause none of the directories to have a note for [A . . . B] and none of the relevant caches has the data. Thus, the directory is not accessed for a data access from [A . . . B] from memory. When the directory has no note and there is a read from memory from [A . . . B], watcher circuitry 110 can cause the NDP to consult the directory.

In some examples, scrubber circuitry 108 is not used and CHA need not be modified to include scrubber circuitry 108. For example, an NDP that is to access a region [A . . . B] can instruct a core to execute invalidation operations covering [A . . . B] in order remove items from the cache, before sleeping the core or before un-plugging a removable memory.

In some examples, when the NDP idles, the NDP can cause the watcher circuitries to enter a sleep state. However, watcher circuitries may be left power-up, so that if watched memory address range(s) are not accessed by cores between, data is not re-scrubbed, and the NDP can access data in the watched memory region without issuing a snoop probe. But if the watched memory is accessed by a core, the watcher circuitry can identify no more valid watched regions, and can enter sleep state or reduced power state. Watcher circuitry 110 may watch regions {J, K, L, M}. For example, if region K is accessed, then region K is removed, leaving {J, L, M} as watched. If all regions are accessed, watcher circuitry 110 may be powered off, with the assumption the next power-on will set the watched regions to null set.

In some examples, watcher circuitry 110 can monitor traffic and discover or report non-temporal stores (NTSs), in which a write of a cache line's worth of data does not need to read the memory, since the bytes are going to be overwritten. Scrubber circuitry 108 can maintain an indicator of whether active snoop filtering is in use. If active filtering or blocking of snoop requests is in use, an NTS can force a memory read. If there is a rate of forced reads that is below a threshold level, watches can be disabled so that NTSes can achieve predictable performance. Where NTSes are used but do not overlap with an active snoop filtering region, use of NTS can maintain information so that an NTSes outside of memory region [A . . . B] do not involve reading memory.

There may be multiple active ranges [A . . . B], [C . . . D], etc., and scrubber circuitry 108 can track regions that do not have an active watch. For example, some addresses do not have an active watch, others might have an active watch, so an NTS can cause a read of memory if there is an active watch, but can avoid the read when there is no active watch.

Some NDP could be in the same chip or device as that of the memory. Some NDP could be integrated in a memory card that includes several memory devices. Some NDP could access or be integrated into a memory channel. Some NDP could be integrated with a memory controller that covers several channels. Some NDP could be integrated with or associated with multiple memory controllers but not specific to a core.

While examples are described with respect to a cache devices, memory devices, NDP, and cores, cache coherency with respect to other types of processors and memory device can be performed using examples described herein. A first processor can include one or more of: a core, accelerator, graphics processing unit (GPU), central processing unit (CPU), microprocessor, NDP, infrastructure processor unit (IPU), data processing unit (DPU), and so forth. A second processor can include one or more of: a core, accelerator, GPU, CPU, microprocessor, NDP, IPU, DPU, and so forth. A memory device can include one or more of: at least one register, at least one cache devices (e.g., level 1 cache (L1), level 2 cache (L2), level 3 cache (L3), last level cache (LLC)), at least one volatile memory device, at least one non-volatile memory device, or at least one persistent memory device.

For example, scrubber circuitry 108 and watcher circuitry 110 can be used for a group of cores on different dies, and the scrub/watch approach allows for work without snoop traffic, as long as cores outside the scrub/watch set have not yet accessed or modified data. For example, given a plurality of groups of cores, where a subset of the groups of cores access the data, CHAs can be queried (e.g., scrubbed) for the subset of groups that have accessed the data, to reduce general queries (e.g., probes) to groups other than the subset of groups.

For example, there may be one CHA per tile, where one or more cores is present per tile. Also note that in some sockets, there may be one or more CHAs for a tile, but a tile may be a core or some other device.

FIG. 2 depicts an example operation. At phase 0, when data in physical address range PALO to PAHI are to be accessed by an NDP0, snoop requests are sent to CHAs associated with cache devices that store data from address range PALO to PAHI.

At phase 1, after cache devices are flushed of data in address range PALO to PAHI are cleared, NDP0 does not issue a snoop request when accessing data in address range PALO to PAHI. In some cases, in connection with a data flush, data in address range PALO to PAHI are written back to memory.

At phase 2, after a device accesses data from address range PALO to PAHI and a cache loads or stores data from address range PALO to PAHI, NDP0 issues a snoop request when accessing data in address range PALO to PAHI. Addresses may be striped or hashed or otherwise distributed across CHAs. So, for example, [A . . . B) may go to CHA0, [B . . . C) may go to CHA1, and so on. In turn, [PALO . . . PAHI) could cover a range of addresses backed by several CHAs. For a load or store, however, the specific address is used to determine which CHA to consult.

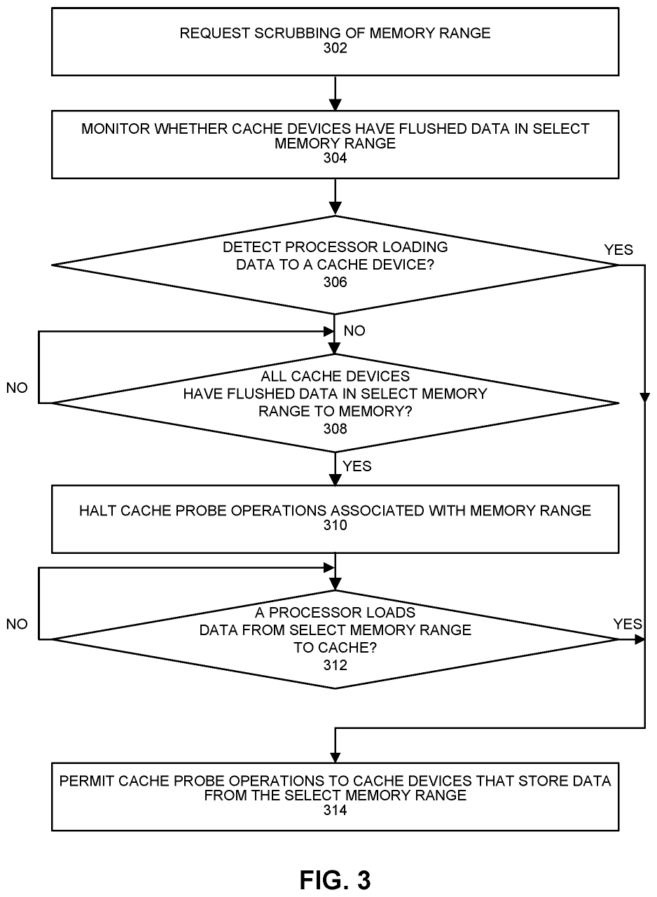

FIG. 3 depicts an example process. The process can be performed by a watcher circuitry. Initially, the watcher is disabled such as when the NDP is idle or that the NDP is active, but it does not currently rely on the watcher. At 300, a watcher can commence watching a memory range for use by a core or device other than the NDP. For example, a watcher can be configured to commence watching a memory range by a command made by an application or through an operating system. At 302, a scrubber can request cache devices to flush data from a memory range. The cache devices are permitted to store data from the memory range. At 304, based on a configuration of the watcher, watcher can monitor whether devices have flushed data in the memory range from cache to memory. Flushing of data can include copying data associated with the memory range from the cache to a memory device. A cache line eviction can be performed to flush the data to memory.

At 306, a determination can be made if a processor loads to a cache device. A load to a cache device can include data associated with the memory range. If the processor loads to a cache, the process can proceed to 314. If the processor does not load to a cache, the process can proceed to 308.

At 308, a determination can be made if all devices have flushed data from their cache. If all devices have flushed data from their cache to memory, the process can proceed to 310. If all devices have not flushed data from their cache to memory, the process can repeat 308 and wait for flushing by the devices to complete. In other words, if a count of the number of cache devices that have flushed data has reached zero, then the process can proceed to 310.

At 310, the watcher does not permit the processor to send snoop requests. For example, a watcher can set Cnt to an initial value and each CHA will report when it is done scrubbing. Each CHA that finishes scrubbing will decrement Cnt. When all scrubbing is done, Cnt=0, and it can switch to no RFOs required.

At 312, a determination can be made if a processor accessed a memory address range that was flushed or scrubbed, before, during, or after scrubbing. Based on a processor accessing a memory address range that was flushed or scrubbed, before, during, or after scrubbing, the process can proceed to 314, so RFOs are issued even after scrubbing finishes. Despite counting a number of CHA that report completion of scrubbing, count does not reach zero. Based on a processor not accessing a memory address range that was flushed or scrubbed, before, during, or after scrubbing, the process can repeat 312.

At 314, the watcher can permit the processor to send snoop requests. For example, a count of non-flushed caches can be greater than zero.

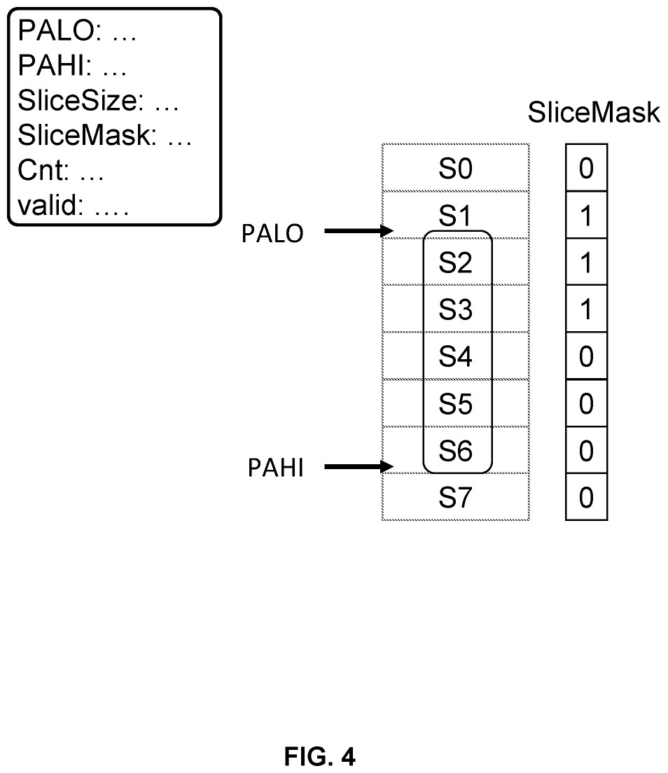

FIG. 4 depicts an example of range division. A range may be sub-divided so if a core accesses one part of the range, the NDP snoops for accesses which overlap with the part touched by the core, Sub-dividing can be performed many ways. One example is “slicing”, in which a range is divided or “sliced” using equal-size chunks.

A slice mask can take the memory address range PALO to PAHI and sub-divide it into pieces (e.g., 8 or 16 or number that is a power of 2) where either snoop probes are to be issued or snoop probes are not to be issued. For example, given a range PALO to PAHI, the size of the memory region is [PAHI-PALO] and can be rounded up to the nearest power of two. For example, if a size is 58 GiB, it can be rounded up to 64 GiB (a power of two). 64 GiB utilizes lg₂(64 GiB), or 36 bits, to represent it. That is, given a 64-bit integer X that holds a value 0 . . . 64 GiB, X[63:36] are all-zeros, and X[35:0] represents the address of the value. If a slice mask has 8 entries, then 3 bits are used to index a slice. If a slice mask has 16 entries, 4 bits are used to index a slice, and so on. For 8 entries and 3 index bits, each slice covers 64 GiB/8=8 GiB. If there were 16 bits, then each slice would cover 64 GiB/16=4 GiB. Bits X[35:33], or bits X[35], X[34], X[33] to select a bit in the Slice Mask. For example, given a load or store to address physical address (PA) that satisfies PALO≤PA≤PAHI, then PA[35:33] can be used select a bit from a Slice Mask. Some Slice Mask bits can be outside PALO to PAHI.

Count (Cnt) can indicate a number in the scrubbing state that indicates in-progress scrubs. Cnt>0 can indicate one or more in-progress scrubs. SliceMask is 0/1 indicates non-NDP accesses to the memory either during scrubs or after scrubs. For addresses corresponding to slices S4 to S6, if Cnt>0, a snoop probe is issued because scrubbing is still in-progress. For slices S4 to S6, if Cnt==0, no snoop probe is not to be issued because scrubbing is completed. A non-NDP access needs to enable snoops, and this may be done by setting Cnt=9999.

Snoops can also be enabled on a per-slice basis, and so SliceMask identifies a slice for which snoops in enabled and Cnt need not be set to 9999 or another value to indicate a non-NDP access.

For an assignment of 0==no snoop probe is needed and 1==snoop probe needed, then initially, for a flush operation involving CHAs, the mask is set to all-zeros and Cnt=32 for 32 CHAs. A processor load/store operation can trigger issuing snoop requests while Cnt>0. A core load/store can set the corresponding bit==1 to indicate a snoop probe is to be performed for the associated address range. When the CHAs finish scrubbing associated cache devices of data associated with the address range, Cnt==0. At this state, if an NDP load/store checks Slice Mask, Slice Mask can indicate a 0 if no snoop probe is to be issued for that load/store operation (based on an associated address) or 1 if a snoop probe is to be issued (based on an associated address).

Referring to the example of FIG. 4, for a load/store that is outside of PALO to PAHI, a snoop probe is to be sent because it is outside the watched range. For a load/store with an address range inside PALO to PAHI corresponding to one or more of slices S1 to S3, a snoop probe is to be issued based on values of 1 in the Slice Mask for slices S1 to S3. A range PALO to PAHI can indicate a range to watch. The range PALO to PAHI do not need to be aligned to a slice boundary. Instead, a snoop can be issued if the address is outside PALO to PAHI or if inside PALO to PAHI but indicated by SliceMask. For example, an address in S6 but above PAHI needs a snoop even though SliceMask==0 (no snoop), because an address above PAHI is outside the watched region.

Where there is a low rate of core reads into [A . . . B], many bits in the slice mask can be set leading to high rates of CHA probes. Some examples monitor core requests and re-establish watches of a memory address region that is actively accessed by the processor but not as actively accessed by cores (or other devices). Such region can be a candidate re-scrub, or perform another scrub operation as described earlier.

For example, a count can be determined and maintained of accesses by a processor and one or more cores of a piece of a memory slice. If a ratio of processor reads to core reads over a period of time is above a threshold or based on the number of processor reads and core reads from the region of memory, then a scrub operation, described with respect to FIG. 3, among other places, can be initiated or re-initiated. If a ratio of processor reads to core reads over a period of time is less than a threshold or based on the number of processor reads and core reads from the region of memory, then the process can continue to issue snoop operations for a memory load or store.

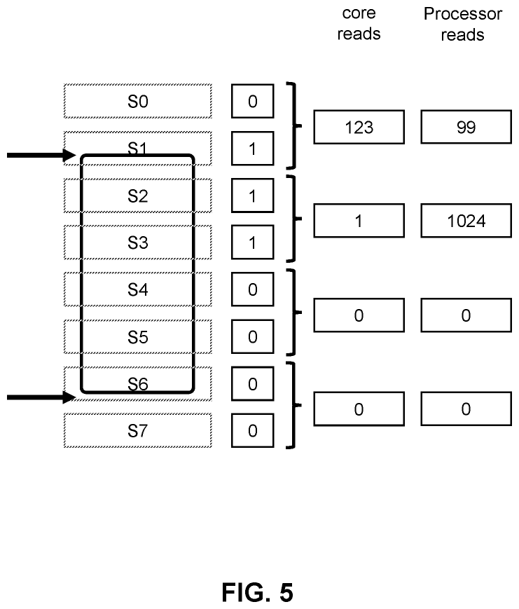

FIG. 5 depicts an example of an operation in which a memory region can be identified to be flushed again. For example, slices S0 to S1 can be associated with more core reads that processor (e.g., accelerator) reads but not more than a threshold level of ratio. For example, slices S2 to S3 can be associated with more processor (accelerator) reads than core reads whereby a threshold level of ratio of processor reads to core reads is exceeded. Memory addresses associated with slices S2 to S3 can be flushed again, SliceMask[S2] and SliceMask[S3] reset to zero, and on completion of re-scrubbing, memory addresses associated with slices S2 and S3 need not be subject to snoop operations but memory addresses associated with slices S0 to S1 can be subject to snoop operations.

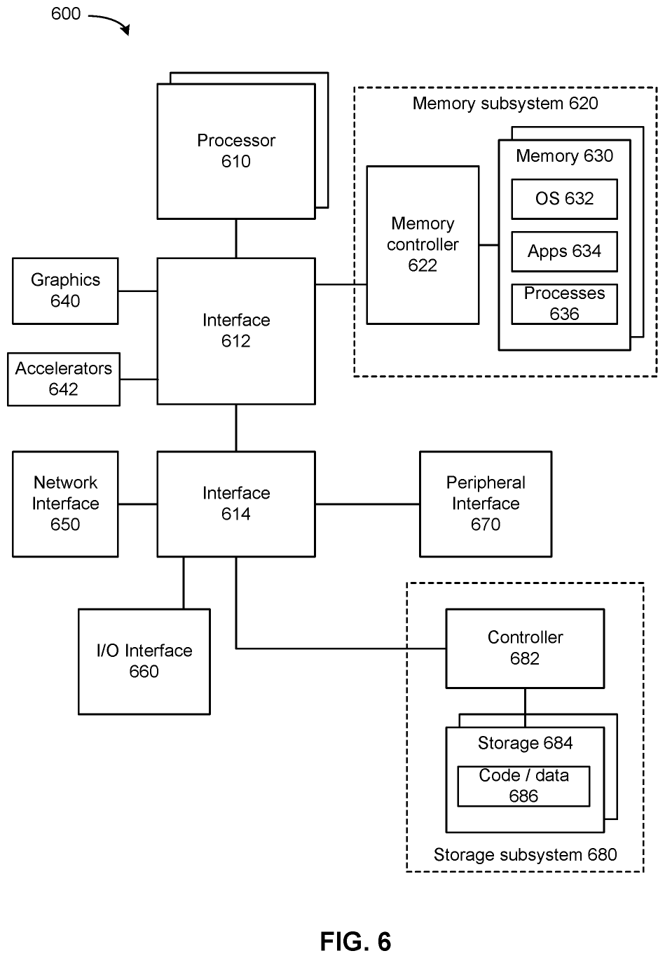

FIG. 6 depicts a system. The system can use embodiments described herein to selectively cause a flush of data from one or more cache or memory devices and disable snoop operations after the data has been flushed from the one or more cache or memory devices in connection with data read operations, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a display that provides an output to a user. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs).

Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on one or more processors sold or designed by Intel®, ARM®, AMD®, Qualcomm®, IBM®, Nvidia®, Broadcom®, Texas Instruments®, among others.

In some examples, a device driver used to enable or disable scrubbing and watching of one or more memory address regions. For example, a processor executes instructions to control scrubbing or watching. A core may execute code which accesses registers (e.g., control registers) to control scrubbing or watching and such code could be in a driver but could also be in a library or incorporated directly into an application.

In some examples, scrubbing and watching of one or more memory address regions could be advertised for use to an application by a driver. In some examples, processors can access feature flags which indicate the current hardware capabilities of scrubbing and watching of one or more memory address regions. In some examples, if a library for scrubbing and watching of one or more memory address regions is linked, such scrubbing and watching feature can be available for use.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. Various embodiments can be used in connection with network interface 650, processor 610, and memory subsystem 620.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

In an example, system 600 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Example 1 includes one or more examples, and includes an apparatus comprising: first circuitry to causes one or more cache devices to discontinue managing accesses to a memory region and second circuitry to indicate when the one or more processors discontinue access to the memory address region associated with one or more cache devices to cease activities related to cache coherency to be sent to the one or more cache devices in connection with an access by a first processor to an address within the memory address region.

Example 2 includes one or more examples, and includes the first processor and a snoop device, wherein the snoop device is to issue one or more snoop probes associated with access to the memory address region until data associated with the memory address region is scrubbed from the one or more cache devices.

Example 3 includes one or more examples, wherein the first processor comprises one or more of a core, accelerator, graphics processing unit (GPU), central processing unit (CPU), microprocessor, NDP, infrastructure processor unit (IPU), data processing unit (DPU), or Compute Express Link (CXL) controller.

Example 4 includes one or more examples, wherein the first processor is to access and process data associated with the memory address region.

Example 5 includes one or more examples, wherein the second circuitry to indicate snoop probes are to be sent to the one or more cache devices based on at least one of the one or more processors accessing data managed by the one or more cache devices.

Example 6 includes one or more examples, wherein to cause one or more processors to discontinue access to a memory address region associated with one or more cache devices, the first circuitry is to cause a writeback of data associated with the memory address region from the one or more cache devices to memory.

Example 7 includes one or more examples, wherein the first circuitry to cause one or more processors to discontinue access to a memory address region associated with one or more cache devices based on an indicator written to a register.

Example 8 includes one or more examples, wherein the first circuitry is part of a cache and home agent (CHA) and the second circuitry is part of a memory controller.

Example 9 includes one or more examples, wherein the memory address region comprises sub-regions which are capable of being managed separately or together or accesses to the memory address region is monitored to initiate operations that trigger discontinuation of one or more snoop probes.

Example 10 includes one or more examples, further including a server, wherein the server comprises the first processor, the first circuitry, the second circuitry, the one or more processors, and a memory device that is to store data associated with the memory address region.

Example 11 includes one or more examples, further including a data center, wherein the data center comprises the server and a second server coupled to the server using a network interface device, the second server is to transmit data to be stored in the memory address region.

Example 12 includes one or more examples, further including a computer-readable medium comprising instructions stored thereon, that if executed by one or more processors, cause the one or more processors to: cause data associated with a memory address region to be flushed from one or more cache devices and configure a processor to access data associated with the memory address region from a memory device without issuance of at least one snoop request based on the data having been flushed from the one or more cache devices.

Example 13 includes one or more examples, wherein the one or more cache devices comprise two or more cache devices and wherein the processor is to access data associated with the memory address region from the memory without issuance of at least one snoop request based on the data having been flushed from the two or more cache devices.

Example 14 includes one or more examples, wherein the cause data associated with a memory address region to be flushed from one or more cache devices comprises cause a writeback of the data associated with the memory address region to a memory device.

Example 15 includes one or more examples, wherein the processor comprises one or more of a core, accelerator, graphics processing unit (GPU), central processing unit (CPU), microprocessor, NDP, infrastructure processor unit (IPU), data processing unit (DPU).

Example 16 includes one or more examples, wherein the memory comprises one or more of: at least one register, at least one cache device, at least one volatile memory device, at least one non-volatile memory device, or at least one persistent memory device.

Example 17 includes one or more examples, further including instructions stored thereon, that if executed by one or more processors, cause the one or more processors to: configure the processor to access data associated with the memory address region from a memory device with issuance of at least one snoop request based on a second processor accessing the data associated with the memory address region.

Example 18 includes one or more examples, further including a method comprising: causing data associated with a memory address region to be flushed from one or more cache devices and configuring a processor to access data associated with the memory address region from a memory device without issuance of at least one snoop request based on the data having been flushed from the one or more cache devices.

Example 19 includes one or more examples, wherein the processor comprises one or more of a core, accelerator, graphics processing unit (GPU), central processing unit (CPU), microprocessor, NDP, infrastructure processor unit (IPU), data processing unit (DPU).

Example 20 includes one or more examples, wherein the causing data associated with a memory address region to be flushed from one or more cache devices comprises causing data associated with a memory address region to be flushed from one or more cache devices comprises cause a writeback of the data associated with the memory address region to a memory device.

Example 21 includes one or more examples, further includes configuring the processor to access data associated with the memory address region from a memory device with issuance of at least one snoop request based on a second processor accessing the data associated with the memory address region.

What is claimed is:

1. An apparatus comprising:
first circuitry to causes one or more cache devices to discontinue managing accesses to a memory region and
second circuitry to indicate when the one or more processors discontinue access to the memory address region associated with one or more cache devices to cease activities related to cache coherency to be sent to the one or more cache devices in connection with an access by a first processor to an address within the memory address region.

2. The apparatus of claim 1, comprising the first processor and a snoop device, wherein the snoop device is to issue one or more snoop probes associated with access to the memory address region until data associated with the memory address region is scrubbed from the one or more cache devices.

3. The apparatus of claim 2, wherein the first processor comprises one or more of a core, accelerator, graphics processing unit (GPU), central processing unit (CPU), microprocessor, NDP, infrastructure processor unit (IPU), data processing unit (DPU), or Compute Express Link (CXL) controller.

4. The apparatus of claim 2, wherein the first processor is to access and process data associated with the memory address region.

5. The apparatus of claim 1, wherein the second circuitry to indicate snoop probes are to be sent to the one or more cache devices based on at least one of the one or more processors accessing data managed by the one or more cache devices.

6. The apparatus of claim 1, wherein to cause one or more processors to discontinue access to a memory address region associated with one or more cache devices, the first circuitry is to cause a writeback of data associated with the memory address region from the one or more cache devices to memory.

7. The apparatus of claim 1, wherein the first circuitry to cause one or more processors to discontinue access to a memory address region associated with one or more cache devices based on an indicator written to a register.

8. The apparatus of claim 1, wherein the first circuitry is part of a cache and home agent (CHA) and the second circuitry is part of a memory controller.

9. The apparatus of claim 1, wherein
the memory address region comprises sub-regions which are capable of being managed separately or together or
accesses to the memory address region is monitored to initiate operations that trigger discontinuation of one or more snoop probes.

10. The apparatus of claim 1, further comprising a server, wherein the server comprises the first processor, the first circuitry, the second circuitry, the one or more processors, and a memory device that is to store data associated with the memory address region.

11. The apparatus of claim 10, further comprising a data center, wherein
the data center comprises the server and a second server coupled to the server using a network interface device,
the second server is to transmit data to be stored in the memory address region.

12. A computer-readable medium comprising instructions stored thereon, that if executed by one or more processors, cause the one or more processors to:
cause data associated with a memory address region to be flushed from one or more cache devices and
configure a processor to access data associated with the memory address region from a memory device without issuance of at least one snoop request based on the data having been flushed from the one or more cache devices.

13. The computer-readable medium of claim 12, wherein the one or more cache devices comprise two or more cache devices and wherein the processor is to access data associated with the memory address region from the memory without issuance of at least one snoop request based on the data having been flushed from the two or more cache devices.

14. The computer-readable medium of claim 12, wherein the cause data associated with a memory address region to be flushed from one or more cache devices comprises cause a writeback of the data associated with the memory address region to a memory device.

15. The computer-readable medium of claim 12, wherein the processor comprises one or more of a core, accelerator, graphics processing unit (GPU), central processing unit (CPU), microprocessor, NDP, infrastructure processor unit (IPU), data processing unit (DPU).

16. The computer-readable medium of claim 12, wherein the memory comprises one or more of: at least one register, at least one cache device, at least one volatile memory device, at least one non-volatile memory device, or at least one persistent memory device.

17. The computer-readable medium of claim 12, comprising instructions stored thereon, that if executed by one or more processors, cause the one or more processors to:
configure the processor to access data associated with the memory address region from a memory device with issuance of at least one snoop request based on a second processor accessing the data associated with the memory address region.

18. A method comprising:
causing data associated with a memory address region to be flushed from one or more cache devices and
configuring a processor to access data associated with the memory address region from a memory device without issuance of at least one snoop request based on the data having been flushed from the one or more cache devices.

19. The method of claim 18, wherein the processor comprises one or more of a core, accelerator, graphics processing unit (GPU), central processing unit (CPU), microprocessor, NDP, infrastructure processor unit (IPU), data processing unit (DPU).

20. The method of claim 18, wherein the causing data associated with a memory address region to be flushed from one or more cache devices comprises causing data associated with a memory address region to be flushed from one or more cache devices comprises cause a writeback of the data associated with the memory address region to a memory device.

21. The method of claim 18, comprising:
configuring the processor to access data associated with the memory address region from a memory device with issuance of at least one snoop request based on a second processor accessing the data associated with the memory address region.
